(19) United States
(12) Patent Application Publication
(10) Pub. No.: US 2005/0271390 A1
(43) Pub. Date: Dec. 8, 2005

(54) Optical clock extraction circuit

(75) Inventor: Seiji Nogiwa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/079,135

(22) Filed: Mar. 15, 2005

(30) Foreign Application Priority Data
Jun. 3, 2004 (JP) 2004-165862

(51) Int. Cl. H04B 10/00

(52) U.S. Cl. 398/155

(57) ABSTRACT

An optical clock extraction circuit that can be fabricated at low cost and suppress jitter is achieved. The optical clock extraction circuit extracts an optical clock signal phase-locked to a high-speed optical data signal. The circuit has a saturable absorber mirror, a pulsed light source for producing an optical pulsed signal consisting of repetitive optical pulses, a first optical coupler/splitter for passing the data signal and causing reflected light of the pulsed signal from the mirror to branch off, a second optical coupler/splitter for passing the pulsed signal, causing it to branch off to take out it as the clock signal, and causing reflected light of the data signal from the mirror to branch off, first and second lenses for collecting the data signal and pulsed signal passed through the coupler/splitters at the same position on the mirror and for returning reflected light rays of the two signals from the mirror to the coupler/splitters, respectively, a balanced photodetector, and an oscillator. The reflected light rays of the signals coming from the mirror and branched off by the coupler/splitters are made to hit the photodetector, which produces an electrical output signal corresponding to the difference in optical power between the incident signals. The oscillator produces a signal to the light source to control the phase of the pulsed signal according to the output from the photodetector.

### BACKGROUND OF THE INVENTION

1. Field of the Invention

The present invention relates to an optical clock extraction circuit for extracting an optical clock signal phase-locked to a high-speed optical data signal and, more particularly, to an optical clock extraction circuit that can be fabricated at reduced cost and reduce jitter.

2. Description of the Prior Art

The prior art literature associated with the conventional optical clock extraction circuits for extracting optical clock signals phase-locked to high-speed optical data signals includes:

JP-A-06-303216

JP-A-09-055699

JP-A-10-209962

JP-A-2000-183862

JP-A-2001-094199

JP-A-2003-101477

E. S. Awad et al.,“Subharmonic Optical Clock Recovery From 160 Gb/s Using Time-Dependent Loss Saturation Inside a Single Electroabsorption Modulator”, IEEE IEEE Photon. Technol. Lett., vol/15, pp. 1764-1766, 2003

FIG. 1 is a structural block diagram of one conventional optical clock extraction circuit disclosed in the above-cited paper by E. S. Awad et al. Shown in FIG. 1 are an optical coupler/splitter 1 and another optical coupler/splitter 3. These devices 1 and 3 combine or split incident rays of light. Also shown are an electroabsorption modulator (EAM) 2 for modulating the intensity of an incident optical signal using the field absorption effect of a semiconductor, a balanced photodetector 4 for producing an electrical output signal corresponding to the difference in intensity between two incident optical signals, a pulsed light source 5 for emitting a pulsed optical signal consisting of repetitive optical pulses of 10 GHz based on an input frequency signal, and an oscillator 6 such as a voltage-controlled oscillator (VCO) for producing a frequency signal based on the input control voltage.

The measured optical signal (hereinafter also referred to as the optical data signal) of 160 Gbit/s indicated by OS01 in FIG. 1 is propagated through an optical waveguide such as an optical fiber and passed into the input terminal of the optical coupler/splitter 1. The optical data signal emitted from the input/output terminal of the optical coupler/splitter 1 propagates through an optical waveguide such as an optical fiber, travels through the electroabsorption modulator 2, and enters the input/output terminal of the optical coupler/splitter 3.

An optical data signal of 160 Gbit/s indicated by OS02 in FIG. 1 is emitted from the branch terminal of the optical coupler/splitter 3, propagates through an optical waveguide such as an optical fiber, and enters one input terminal of the balanced photodetector 4.

Meanwhile, the optical pulsed signal of a repetition frequency of 10 GHz that is the output light from the pulsed light source 5 as indicated by OC01 in FIG. 1 propagates through an optical waveguide such as an optical fiber and enters the input terminal of the optical coupler/splitter 3. The optical pulsed signal emitted from the input/output terminal of the optical coupler/splitter 3 propagates through an optical waveguide such as an optical fiber, goes through the electroabsorption modulator 2, and enters the input/output terminal of the optical coupler/splitter 1.

In addition, the optical pulsed signal having a repetition frequency of 10 GHz as indicated by OC02 in FIG. 1 is launched from the branch terminal of the optical coupler/splitter 1, propagates through an optical waveguide such as an optical fiber, and enters the other input terminal of the balanced photodetector 4.

The output signal from the balanced photodetector 4 is entered into the control input terminal of the oscillator 6. A frequency signal that is the output from the oscillator 6 is coupled into the control input terminal of the pulsed light source 5.

The operation of the conventional structure shown in FIG. 1 is now described by referring to FIGS. 2, 3, and 4. FIG. 2 is a diagram showing examples of absorption saturation characteristics of the optical data signal produced from the electroabsorption modulator 2 and of the optical pulsed signal. FIG. 3 is a diagram showing one example of the relation between the differential signal outputted by the balanced photodetector 4 and the phase difference between the optical data signal and optical pulsed signal. FIG. 4 is a timing chart showing the phase relationship between the optical data signal and an optical pulsed signal.

In FIG. 2, CC11 indicates the absorption saturation characteristics of an optical pulsed signal entered as indicated by OC01 in FIG. 1. In FIG. 2, CS11 indicates the absorption saturation characteristics of an optical data signal entered as indicated by OS01 in FIG. 1.

When the optical data signal and optical pulsed signal having such absorption saturation characteristics enter the balanced photodetector 4, the difference in optical power between these two signals is produced as an electrical output signal as indicated by CH21 in FIG. 3.

In the portion SL21 (FIG. 3) of the electrical signal CH21 in FIG. 3, the difference is displaced linearly relative to the phase difference between the optical data signal and optical pulsed signal. Therefore, the oscillator 6 is controlled, using this output from the balanced photodetector 4 as a control voltage signal. The phase of the optical pulsed signal of the pulsed light source is controlled by a frequency signal that is the output signal from the oscillator 6. In this way, the optical pulsed signal can be phase-locked to the optical data signal.

Specifically, the optical pulsed signal can be phase-locked to the optical data signal by controlling the phase of the optical pulsed signal of the pulsed light source 5 such that the phase difference between the optical data signal and the optical pulsed signal becomes null by making use of the characteristics indicated by SL21 in FIG. 3.

For example, by providing such phase-locked control, an optical pulsed signal having a repetition frequency of 10 GHz as shown in FIG. 4B and phase-locked to the optical data signal of 160 Gbit/s shown in FIG. 4A is produced from the pulsed light source 5.

However, in the conventional example shown in FIG. 1, the absorption saturation characteristics of the electroabsorption modulator 2 have relatively long absorption saturation times of about 20 to 40 ps as indicated by CC11 and CS11 in FIG. 2. In other words, the recovery time from absorption saturation is long. Therefore, where the entered optical data signal has a high bit rate, the signal is easily affected by adjacent bits of the optical pulses. The characteristics of the electrical signal produced from the balanced photodetector are also affected. Finally, there is the problem that jitter is produced in the timing of the optical pulsed signal.

Furthermore, with respect to the electroabsorption modulator 2, electrodes for applying voltages must be fabricated by processing a semiconductor multilayer film into a waveguide. Also, insulation must be provided between the electrodes, and soon. Consequently, the modulator is complex in structure and costly to fabricate. In addition, the waveguide results in scattering loss. When an optical signal is coupled to a waveguide, a coupling loss occurs. In this way, large optical losses take place, reducing the amount of variation in absorption. This increases noise in the output light. Jitter is produced in the timing of the optical pulsed signal.

### SUMMARY OF THE INVENTION

It is an object of the present invention to provide an optical clock extraction circuit that can be fabricated at low cost and reduce jitter.

### BRIEF DESCRIPTION OF THE DRAWINGS

FIG. 1 is a structural block diagram showing one example of a conventional optical clock extraction circuit;

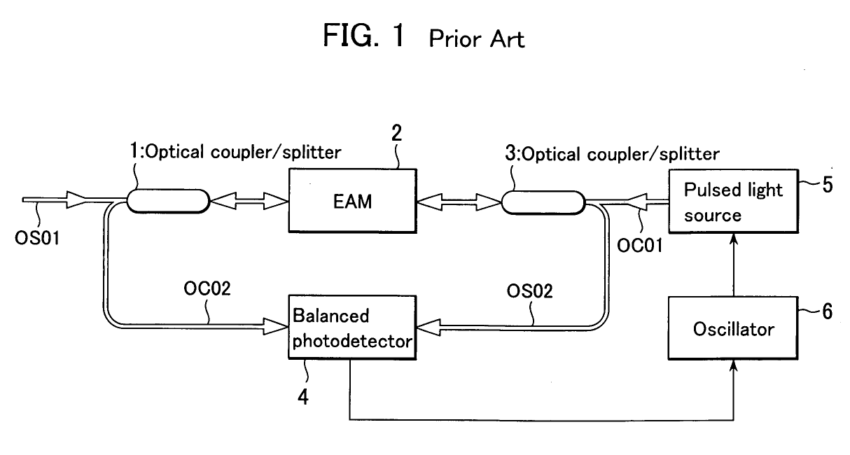

FIG. 2 is a diagram showing examples of absorption saturation characteristics of optical data signal and optical pulsed signal produced by an electroabsorption modulator;

FIG. 3 is a diagram showing one example of relation between a differential signal produced by a balanced photodetector and the phase difference between the optical data signal and optical pulsed signal;

FIG. 4 is a timing diagram showing the phase relationship between the optical data signal and optical pulsed signal;

FIG. 5 is a structural block diagram showing one example of optical clock extraction circuit according to the invention;

FIG. 6 is a cross-sectional view illustrating one specific example of saturable absorber mirror;

FIG. 7 is a structural block diagram of another optical clock extraction circuit according to the present invention;

FIG. 8 is a structural block diagram of a further optical clock extraction circuit according to the present invention; and

FIG. 9 is a structural block diagram of a still other optical clock extraction circuit according to the present invention.

### DETAILED DESCRIPTION OF THE PREFERRED EMBODIMENTS

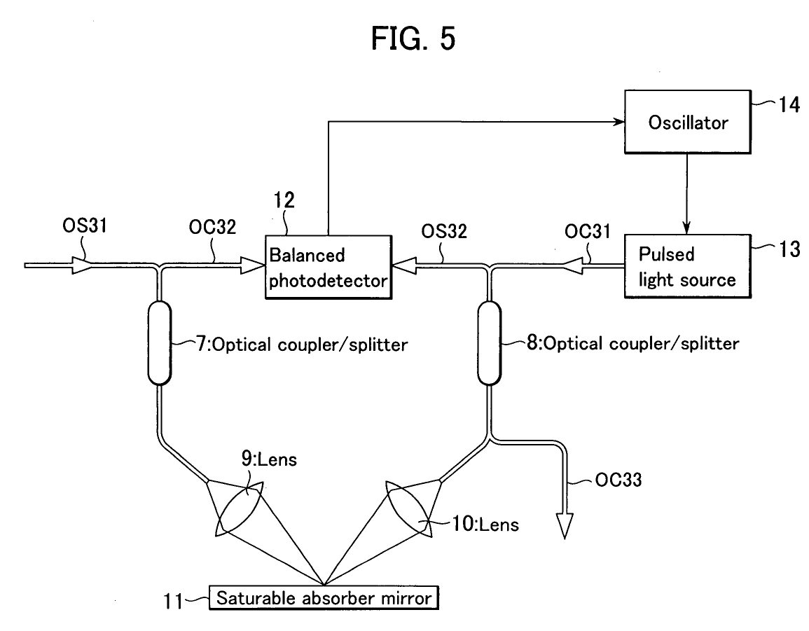

The present invention is hereinafter described in detail with reference to the drawings. FIG. 5 is a structural block diagram of one optical clock extraction circuit according to the present invention. Shown in FIG. 5 are an optical coupler/splitter 7, another optical coupler/splitter 8, lenses 9, 10, a saturable absorber mirror 11, a balanced photodetector 12 for producing an electrical output signal corresponding to the difference in intensity between two incident optical signals, a pulsed light source 13 such as an actively mode-locked laser for emitting an optical pulsed signal consisting of repetitive optical pulses of 10 GHz according to an input frequency signal, and an oscillator 14 such as a voltage-controlled oscillator (VCO) for producing a frequency signal according to an input control voltage. The coupler/splitter 7 and coupler/splitter 8 combine or split incident light rays.

Referring still to FIG. 5, the optical data signal of 160 Gbit/s indicated by OS31 propagates through an optical waveguide such as an optical fiber and enters the input terminal of the optical coupler/splitter 7. The optical data signal emitted from the input/output terminal of the optical coupler/splitter 7 propagates through an optical waveguide such as an optical fiber and is collected onto the saturable absorber mirror 11 via the lens 9.

The optical data signal reflected by the saturable absorber mirror 11 is collected into an optical waveguide such as an optical fiber via the lens 10 and passed into the input/output terminal of the optical coupler/splitter 8.

The optical data signal of 160 Gbit/s indicated by OS32 in FIG. 5 is emitted from the first branch terminal of the optical coupler/splitter 8, propagates through an optical waveguide such as an optical fiber, and passed into one input terminal of the balanced photodetector 12.

Meanwhile, the optical pulsed signal having a repetition frequency of 10 GHz and delivered from the pulsed light source 13 indicated by OC31 in FIG. 5 propagates through an optical waveguide such as an optical fiber and enters the input terminal of the optical coupler/splitter 8. The optical pulsed signal emitted from the input/output terminal of the optical coupler/splitter 8 propagates through an optical waveguide such as an optical fiber and is collected at the same position as the collection position of the optical data signal on the saturable absorber mirror 11 via the lens 10.

The optical pulsed signal reflected by the saturable absorber mirror 11 is collected into an optical waveguide such as an optical fiber via the lens 9 and passed into the input/output terminal of the optical coupler/splitter 7.

The optical pulsed signal having a repetition frequency of 10 GHz indicated by OC32 in FIG. 5 is emitted from the branch terminal of the optical coupler/splitter 7, propagates through an optical waveguide such as an optical fiber, and enters the other input terminal of the balanced photodetector 12.

The optical pulsed signal is taken out as an optical clock signal from the second branch terminal of the optical coupler/splitter 8 as indicated at OC33 in FIG. 5.

The output signal from the balanced photodetector 12 is applied to the control input terminal of the oscillator 14. A frequency signal that is the output from the oscillator 14 is coupled to the control input terminal of the pulsed light source 13.

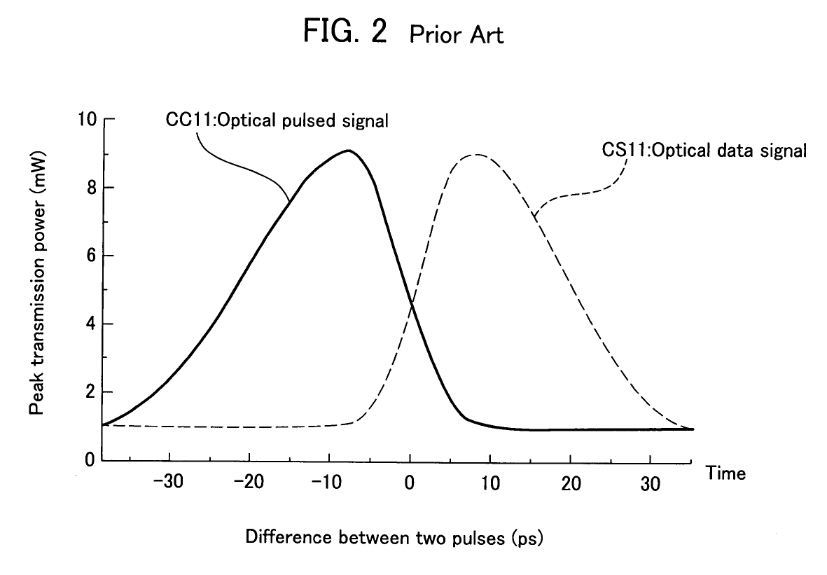

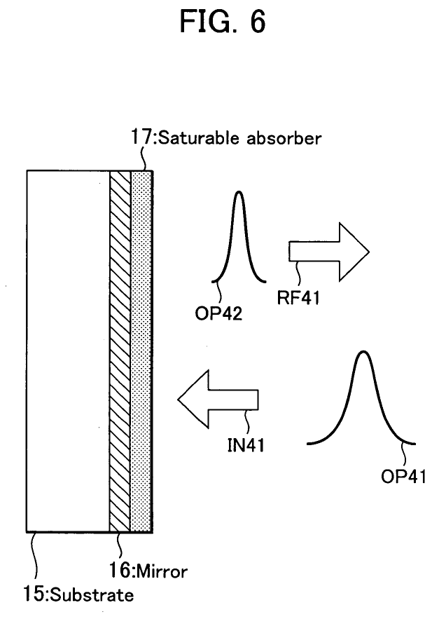

The operation of the embodiment shown in FIG. 5 is now described by referring to FIGS. 2, 3, 4, and 6. FIG. 6 is a cross-sectional view illustrating a specific example of the saturable absorber mirror 11. FIGS. 2-4 have been already used in the description of the conventional example.

Shown in FIG. 6 are a substrate 15such as a semiconductor, a mirror 16, and a saturable absorber mirror 17. When the optical power is low, the absorber mirror absorbs the incident light. When the optical power is high, the absorber mirror transmits the incident light. The mirror 16 is formed on the substrate 15. The saturable absorber mirror 17 is formed on the surface of the mirror 16.

The saturable absorber mirror 17 absorbs the incident light in a case where the optical power is low and transmits the incident light in a case where the optical power is high. Therefore, where the optical power is high, the incident light is reflected by the mirror 16 and made to exit.

For example, where an optical pulsed signal having a profile as indicated by OP41 in FIG. 6 is entered into the saturable absorber mirror 11 as indicated by IN41 in FIG. 6, the tail portion of the optical pulsed signal of low optical power is absorbed. The optical pulsed signal of a profile obtained by emphasizing the peak portion of the optical pulsed signal of the profile as indicated by OP42 in FIG. 6 is reflected as indicated by RF41 in FIG. 6 and made to exit.

Therefore, the absorption saturation characteristics of the saturable absorber mirror 11 are made similar in profile with the absorption saturation characteristics of the electroabsorption modulator in the conventional example. For example, the profile of the absorption saturation characteristics of an optical pulsed signal entered as indicated by OC31 in FIG. 5 is made similar to the profile indicated by CC11 in FIG. 2. The profile of the absorption saturation characteristics of the optical data signal entered as indicated by OS31 in FIG. 5 is made similar to the profile indicated by CS11 in FIG. 2.

However, the electroabsorption modulator contains no lattice defects. On the other hand, the saturable absorber mirror 11 (more strictly, saturable absorber 17) contains lattice defects and therefore has shorter carrier life times. For this reason, recovery from a saturated state is quicker. The absorption saturation characteristics of the saturable absorber mirror 11 have a shorter absorption saturation recovery time compared with the absorption saturation characteristics of the electroabsorption modulator.

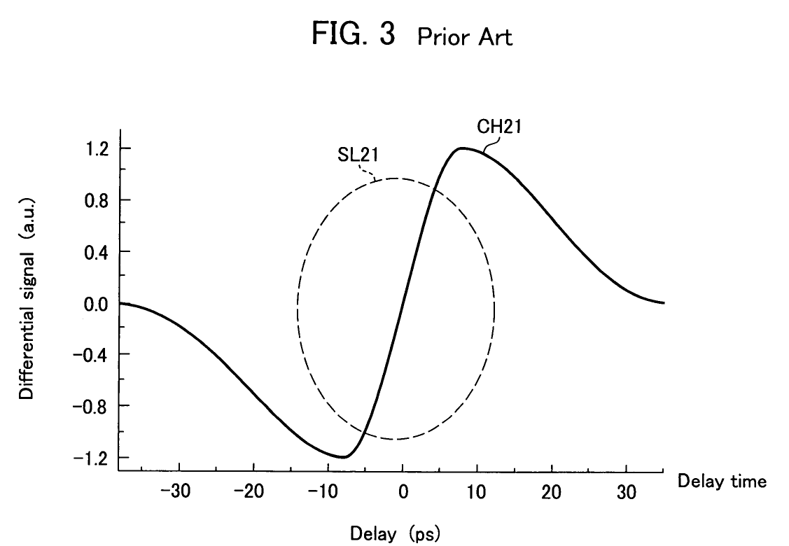

When the reflected light rays of the optical data signal and optical pulsed signal having such absorption saturation characteristics enter the balanced photodetector 12, the difference in optical power between these two signals is produced as an electrical output signal as indicated by CH21 in FIG. 3.

In the portion-indicated by SL21 in FIG. 3 of the electrical signal indicated by CH21 in FIG. 3, the difference is displaced linearly relative to the phase difference between the optical data signal and-optical pulsed signal. Therefore, the oscillator 14 is controlled using the output from the balanced photodetector 12 as a control voltage signal. The phase of the optical pulsed signal of the pulsed light source is controlled by a frequency signal that is the output signal from the oscillator 14. Thus, the optical pulsed signal can be phase-locked to the optical data signal.

In particular, the optical pulsed signal can be phase-locked to the optical data signal by controlling the phase of the optical pulsed signal of the pulsed light source 13 by making use of the characteristics indicated by SL21 in FIG. 3 such that the phase difference between the optical data signal and optical pulsed signal becomes null.

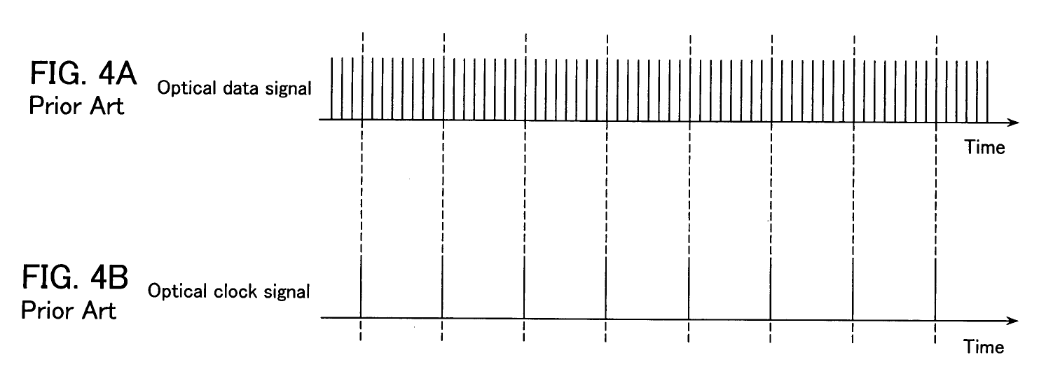

For example, by providing such phase-locked control, an optical pulsed signal having a repetition frequency of 10 GHz as shown in FIG. 4B is delivered from the pulsed light source 13, the pulsed signal being phase-locked to the optical data signal of 160 Gbit/s as shown in FIG. 4A.

That is, even where the entered optical data signal has a high bit rate, the effects of adjacent bits of the optical pulses are reduced by using the saturable absorber mirror 11 having a short recovery time from absorption saturation. The characteristics of the electrical signal delivered from the balanced photodetector are also improved. Jitter in the timing of the optical pulsed signal can be reduced.

As a result, jitter can be reduced by making the optical data signal and optical pulsed signal hit the same position on the saturable absorber mirror having a short recovery time from absorption saturation, causing their reflecting light rays to return to the optical paths for the incident light of the optical pulsed signal and the incident light of the optical data signal, detecting their reflected light rays by the balanced photodetector, and phase-locking the optical pulsed signal to the optical data signal based on an electrical signal corresponding to the obtained difference.

The configuration is only that the optical data signal and optical pulsed signal are made to hit the same position on the saturable absorber mirror such that the signals are reflected. Therefore, optical losses such as scattering loss and coupling loss can be suppressed. In consequence, jitter can be decreased.

Furthermore, the saturable absorber mirror is simpler in structure than the electroabsorption modulator that needs electrodes and insulation between the electrodes used to apply voltages; the electrodes are fabricated by processing a semiconductor multilayer film into a waveguide. Hence, the fabrication cost can be suppressed.

In the embodiment shown in FIG. 5, the optical signal is split by the use of the optical coupler/splitter 7 and coupler/splitter 8. Instead of the optical coupler/splitters, optical circulators may be used.

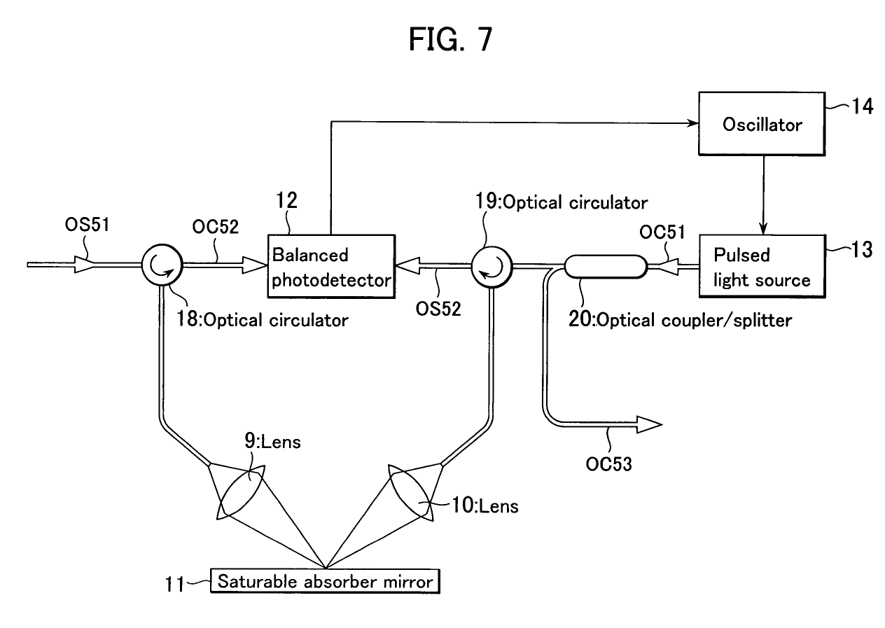

FIG. 7 is a structural block diagram of other optical clock extraction circuit according to the invention.

In FIG. 7, lens 9, lens 10, saturable absorber mirror 11, balanced photodetector 12, pulsed light source 13, and oscillator 14 are indicated by the same reference numerals as in FIG. 5. Optical circulators 18, 19 and an optical coupler/splitter 20 are also shown. Each of the circulators 18 and 19 has three optical input/output ports. Only one optical input/output port of the circulator 18 and only one optical input output port 19 which are adjacent to each other are coupled.

For simplicity of illustration, it is assumed that incident light passed into the first optical input/output port of an optical circulator is made to exit (passed) from the second optical input/output port, incident light passed into the second optical input/output port is made to exit (branched) from the third optical input/output port, and incident light entered from the third optical input/output port is made to exit from the first optical input/output port.

The optical data signal of 160 Gbit/s indicated by OS51 in FIG. 7 propagates through an optical waveguide such as an optical fiber and is passed into the first optical input/output port of the optical circulator 18. The optical data signal exiting (passed) from the second optical input/output port of the circulator 18 propagates through an optical waveguide such as an optical fiber and is collected onto the saturable absorber mirror 11 via the lens 9.

The optical data signal reflected by the saturable absorber mirror 11 is collected into an optical waveguide such as an optical fiber via the lens 10 and passed into the second optical input/output port of the circulator 19.

Furthermore, the optical data signal of 160 Gbit/s indicated by OS52 in FIG. 7 is made to exit (branched) from the third optical input/output port of the circulator 19, propagates through an optical waveguide such as an optical fiber, and passed into one input terminal of the balanced photodetector 12.

Meanwhile, the optical pulsed signal with a repetition frequency of 10 GHz (indicated by OC51 in FIG. 7) that is the output light from the pulsed light source 13 propagates through an optical waveguide such as an optical fiber and is passed into the input terminal of the optical coupler/splitter 20. The optical pulsed signal exiting from the output terminal of the optical coupler/splitter 20 propagates through an optical waveguide such as a fiber and is passed into the first optical input/output port of the optical circulator 19. The optical data signal exiting (passed) from the second optical input/output port of the circulator 19 propagates through an optical waveguide such as an optical fiber and is collected at the same position as the collection position of the optical data signal on the saturable absorber mirror 11 via the lens 10.

The optical pulsed signal reflected by the saturable absorber mirror 11 is collected into an optical waveguide such as an optical fiber via the lens 9 and passed into the second optical input/output port of the circulator 18.

The optical pulsed signal with a repetition frequency of 10 GHz indicated by OC52 in FIG. 7 is made to exit (branched) from the third optical input/output port of the optical circulator 18, propagates through an optical waveguide such as an optical fiber, and is passed into the other input terminal of the balanced photodetector 12.

An optical pulsed signal is taken out as an optical clock signal from the branch terminal of the optical coupler/splitter 20 as indicated by OC53 in FIG. 7.

The output signal from the balanced photodetector 12 is input into the control input terminal of the oscillator 14. A frequency signal that is the output from the oscillator 14 is coupled to the control input terminal of the pulsed light source 13.

The operation of the embodiment shown in FIG. 7 is similar to the operation of the embodiment shown in FIG. 5 except that the optical coupler/splitter 7 and optical coupler/splitter 8 are replaced by optical circulators 18 and 19, respectively, and that an optical coupler/splitter 20 is added to take out the optical clock signal. Since the operation is similar to the operation of the embodiment of FIG. 5, its detail description is omitted.

In this case, branch loss is present in the optical coupler/splitter. However, the optical circulators 18 and 19 can transfer reflected light rays of the optical data signal and optical pulsed signal from the saturable absorber mirror 11 to the balanced photodetector 12 efficiently. Since optical loss can be suppressed further, jitter can be reduced further.

Where the pulsed light source has two optical output ports, the optical clock signal may be directly taken from the pulsed light source.

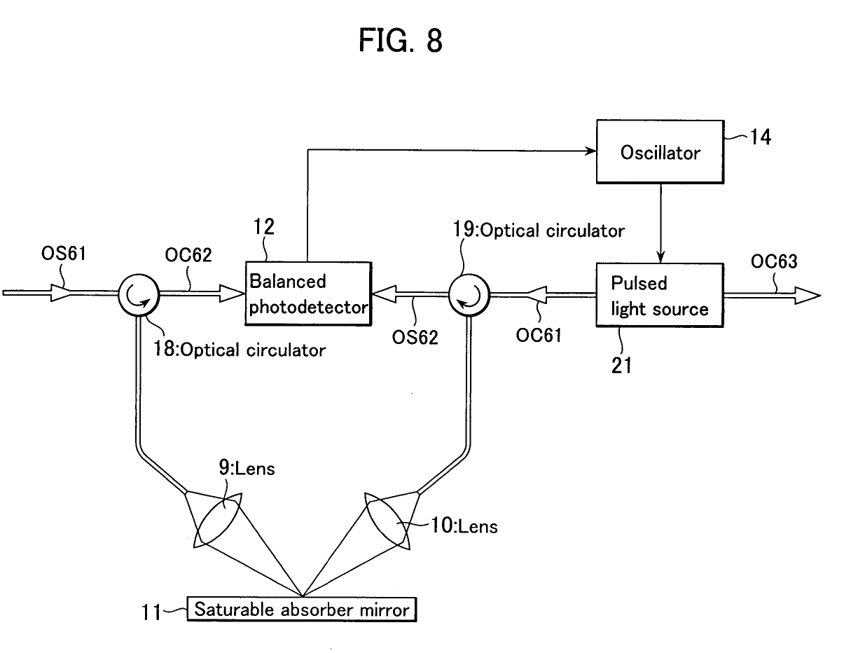

FIG. 8 is a structural block diagram of another optical clock extraction circuit according to the invention. In FIG. 8, lens 9, lens 10, saturable absorber mirror 11, balanced photodetector 12, oscillator 14, and optical circulators 18, 19 are indicated by the same numerals as in FIG. 7. In addition, a pulsed light source 21 such as an actively mode-locked laser having two optical output ports is shown.

For simplicity of illustration, it is assumed that incident light passed into the first optical input/output port of an optical circulator is made to exit (passed) from the second optical input/output port, incident light passed into the second optical input/output port is made to exit (branched) from the third optical input/output port, and incident light passed into the third optical input/output port is made to exit from the first optical input/output port.

The optical data signal of 160 Gbit/s indicated by OS61 in FIG. 8 propagates through an optical waveguide such as an optical fiber and is passed into the first optical input/output port of the optical circulator 18. The optical data signal exiting (passed) from the second optical input/output port of the circulator 18 propagates through an optical waveguide such as an optical fiber and is collected onto the saturable absorber mirror 11 via the lens 9.

The optical data signal reflected by the saturable absorber mirror 11 is collected into an optical waveguide such as an optical fiber via the lens 10 and passed into the second optical input/output port of the circulator 19.

Furthermore, the optical data signal of 160 Gbit/s indicated by OS62 in FIG. 8 is made to exit (branched) from the third optical input/output port of the circulator 19, propagates through an optical waveguide such as an optical fiber, and is passed into one input terminal of the balanced photodetector 12.

Meanwhile, the optical pulsed signal with a repetition frequency of 10 GHz (indicated by OC61 in FIG. 8) that is the output light from the first optical output port of the pulsed light source 21 propagates through an optical waveguide such as fiber and is passed into the first optical input/output port of the optical circular 19. The optical data signal exiting (passed) from the second optical input/output port of the optical circular 19 propagates through an optical waveguide such as an optical fiber and is collected onto the same position as the collection position of the optical data signal on the saturable absorber mirror 11 via the lens 10.

The optical pulsed signal reflected by the saturable absorber mirror 11 is collected into an optical waveguide such as an optical fiber via the lens 9 and passed into the second optical input/output port of the circulator 18.

The optical pulsed signal with a repetition frequency of 10 GHz indicated by OC62 in FIG. 8 is made to exit (branched) from the third optical input/output port of the optical circulator 18, propagates through an optical waveguide such as an optical fiber, and is passed into the other input terminal of the balanced photodetector 12.

An optical pulsed signal is taken out as an optical clock signal from the second optical output port of the pulsed light source 21 as indicated by OC63 in FIG. 8.

The output signal from the balanced photodetector 12 is input into the control input terminal of the oscillator 14. A frequency signal that is the output from the oscillator 14 is coupled to the control input terminal of the pulsed light source 21.

The operation of the embodiment shown in FIG. 8 is similar to the operation of the embodiment shown in FIG. 7 except that the pulsed light source 13 and optical coupler/splitter 20 are replaced by a pulsed light source 21 having two optical output ports. Since the operation is similar to the operation of the embodiment of FIG. 5, its detail description is omitted.

In this case, an optical clock signal is directly taken out from the pulsed light source 21 without via the optical coupler/splitter 20 having branch loss. Therefore, optical loss in the optical clock signal can be suppressed.

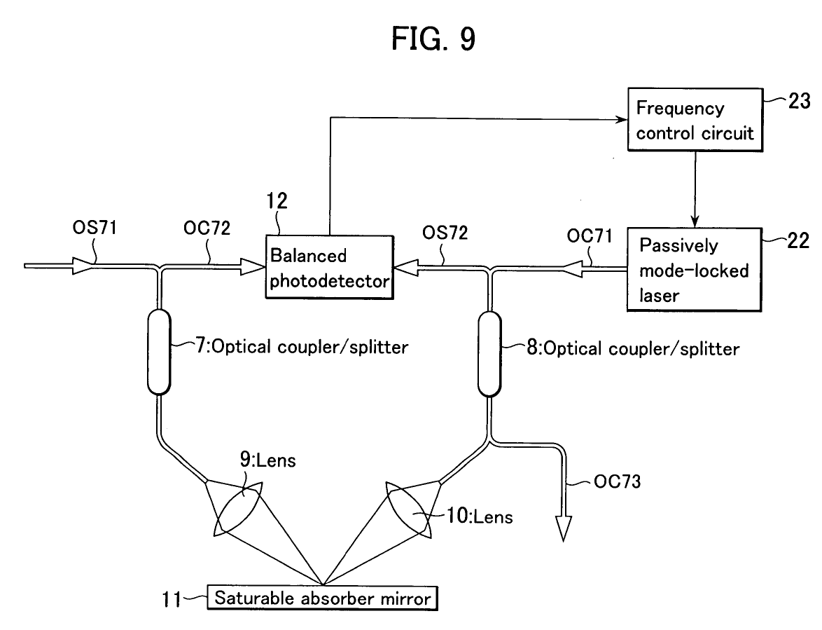

In the embodiments shown in FIGS. 5, 7, and 8, an actively mode-locked laser is used as the pulsed light source. A passively mode-locked laser capable of mode locking without entering a frequency signal from the outside may also be used as the pulsed light source. FIG. 9 is a structural block diagram showing another example of the optical clock extraction circuit according to the present invention. In FIG. 9, optical coupler/splitter 7, optical coupler/splitter 8, lenses 9, 10, saturable absorber mirror 11, and balanced photodetector 12 are indicated by the same numerals as in FIG. 5. A passively mode-locked laser 22 and a frequency control circuit 23 are also shown. The laser 22 emits an optical pulsed signal consisting of optical pulses with a repetition frequency of 10 GHz.

The optical data signal of 160 Gbit/s indicated by OS71 in FIG. 9 propagates through an optical waveguide such as an optical fiber and is passed into the input terminal of the optical coupler/splitter 7. The optical data signal emitted from the input/output terminal of the optical coupler/splitter 7 propagates through an optical waveguide such as an optical fiber and is collected onto the saturable absorber mirror 11 via the lens 9.

The optical data signal reflected by the saturable absorber mirror 11 is collected into an optical waveguide such as an optical fiber via the lens 10 and made incident on the input/output terminal of the optical coupler/splitter 8.

Furthermore, the optical data signal of 160 Gbit/s indicated by OS72 in FIG. 9 is made to exit from the first branch terminal of the optical coupler/splitter 8, propagates through an optical waveguide such as an optical fiber, and is passed into one input terminal of the balanced photodetector 12.

Meanwhile, the optical pulsed signal with a repetition frequency of 10 GHz (indicated by OC71 in FIG. 9) that is the output light from the passively mode-locked laser 22 propagates through an optical waveguide such as an optical fiber and is passed into the input terminal of the optical coupler/splitter 8. The optical pulsed signal exiting from the input/output terminal of the optical coupler/splitter 8 propagates through an optical waveguide such as an optical fiber and is collected at the same position as the collection position of the optical data signal on the saturable absorber mirror 11 via the lens 10.

The optical pulsed signal reflected by the saturable absorber mirror 11 is collected into an optical waveguide such as an optical fiber via the lens 9 and passed into the input/output terminal of the optical coupler/splitter 7.

The optical pulsed signal with a repetition frequency of 10 GHz indicated by OC72 in FIG. 9 is made to exit from the branch terminal of the optical coupler/splitter 7, propagates through an optical waveguide such as an optical fiber, and is passed into the other input terminal of the balanced photodetector 12.

An optical pulsed signal is taken out as an optical clock signal from the second branch terminal of the optical coupler/splitter 8 as indicated by OC73 in FIG. 9.

The output signal from the balanced photodetector 12 is input into the control input terminal of the frequency control circuit 23. The output from the frequency control circuit 23 is coupled to the passively mode-locked laser 22.

The operation of the embodiment shown in FIG. 9 is described. Since the fundamental operation is similar to the operation of the embodiment shown in FIG. 5, its description is omitted.

The passively mode-locked laser 22 has a resonator made up of two mirrors. A saturable absorber mirror is used as one of the two mirrors. Laser output light of low optical power is absorbed by the saturable absorber mirror such that only laser light in a certain mode is emitted.

At this time, the output frequency is controlled by controlling the width of the resonator (i.e., the space between the saturable absorber mirror and the other mirror) of the passively mode-locked laser according to the output from the frequency control circuit 23. In this case, jitter can be reduced further compared with the case in which an actively mode-locked laser is used as the pulsed light source.

A semiconductor saturable absorber mirror (SESAM) or a saturable absorber mirror using carbon nanotubes can be employed as the saturable absorber mirror 11.

Especially, the recovery time of a carbon nanotube-based saturable absorber mirror from absorption saturation is as short as subpicoseconds. Therefore, if the optical data signal has a very high bit rate, an optical clock signal with low jitter can be extracted.

In the description of the embodiment shown in FIG. 5, the optical signal propagates through an optical waveguide such as an optical fiber. Of course, various elements such as optical coupler/splitters may be arranged such that the optical signal can be directly propagated through air without using an optical waveguide such as an optical fiber.

As described so far, the present invention yields the following advantages. According to any one of first, second, third, fourth, fifth, sixth, and eighth aspects of the present invention, an optical data signal and an optical pulsed signal are made to hit the same position on a saturable absorber mirror having a short recovery time from absorption saturation. Their reflected light rays are returned to optical paths for the incident light of the optical pulsed signal and the incident light of the optical data signal. Their reflected light rays are detected by a balanced photodetector. The optical pulsed signal is phase-locked to the optical data signal based on an electrical signal corresponding to the obtained difference. Consequently, jitter can be reduced. The configuration is only that the optical data signal and optical pulsed signal are made to hit the same position on the saturable absorber mirror and reflect. Consequently, optical losses such as scattering loss and coupling loss can be suppressed. Hence, jitter can be reduced. Moreover, the saturable absorber mirror is simpler in structure than an electroabsorption modulator that needs electrodes and insulation between the electrodes used to apply voltages, the electrodes being fabricated by processing a semiconductor multilayer film into a waveguide. As a result, the fabrication cost can be suppressed.

According to a seventh aspect of the invention, the saturable absorber mirror uses carbon nanotubes. Since the recovery time of this saturable absorber mirror using carbon nanotubes from absorption saturation has a very small value of subpicoseconds, an optical clock signal with low jitter can be extracted even if the optical data signal has a very high bit rate.

1. An optical clock extraction circuit for extracting an optical clock signal phase-locked to a high-speed optical data signal, said optical clock extraction circuit comprising:
a saturable absorber mirror;
a pulsed light source for producing an optical pulsed signal consisting of repetitive optical pulses;
a first optical coupler/splitter for passing said optical data signal and causing reflected light of said optical pulsed signal from said saturable absorber mirror to branch off;
a second optical coupler/splitter for passing said optical pulsed signal and causing it to branch off to take out it as said optical clock signal, said second optical coupler/splitter also acting to cause reflected light of said optical data signal from said saturable absorber mirror to branch off;
first and second lenses for collecting said optical data signal and optical pulsed signal passed through said first and second optical coupler/splitters at the same position on said saturable absorber mirror and for returning reflected light rays of said optical pulsed signal and optical data signal from said saturable absorber mirror to said first and second optical coupler/splitters, respectively;
a balanced photodetector on which the reflected light rays of said optical pulsed signal and optical data signal coming from said saturable absorber mirror and branched off by said first and second optical coupler/splitters impinge, the balanced photodetector producing an electrical output signal corresponding to the difference in optical power between the impinging signals; and
an oscillator for producing a signal to said pulsed light source, the signal being used to control phase of said optical pulsed signal based on the output signal from the balanced photodetector.

2. An optical clock extraction circuit for extracting an optical clock signal phase-locked to a high-speed optical data signal, said optical clock extraction circuit comprising:
a saturable absorber mirror;
a pulsed light source for producing an optical pulsed signal consisting of repetitive optical pulses;
a first optical circulator for passing said optical data signal and causing reflected light of said optical pulsed signal from said saturable absorber mirror to branch off;
an optical coupler/splitter for passing said optical pulsed signal and causing it to branch off to take out it as said optical clock signal;
a second optical circulator for passing said optical pulsed signal passed through the optical coupler/splitter and for causing reflected light of said optical data signal from said saturable absorber mirror to branch off;
first and second lenses for collecting said optical data signal and optical pulsed signal passed through said first and second optical circulators at the same position on said saturable absorber mirror and for returning reflected light rays of said optical pulsed signal and optical data signal from said saturable absorber mirror to said first and second optical circulators, respectively;
a balanced photodetector on which the reflected light rays of said optical pulsed signal and optical data signal coming from said saturable absorber mirror and branched off by said first and second optical circulators impinge, the balanced photodetector producing an electrical output signal corresponding to the difference in optical power between the impinging signals; and
an oscillator for producing a signal to said pulsed light source, the signal being used to control phase of said optical pulsed signal based on the output signal from the balanced photodetector.

3. An optical clock extraction circuit for extracting an optical clock signal phase-locked to a high-speed optical data signal, said optical clock extraction circuit comprising:
a saturable absorber mirror;
a pulsed light source having two ports each of which produces an optical pulsed signal consisting of repetitive optical pulses;
a first optical circulator for passing said optical data signal and causing reflected light of said optical pulse signal from said saturable absorber mirror to branch off;
a second optical circulator for passing said optical pulsed signal and causing reflected light of said optical data signal from said saturable absorber mirror to branch off;
first and second lenses for collecting said optical data signal and optical pulsed signal passed through said first and second optical circulators at the same position on said saturable absorber mirror and for returning reflected light rays of said optical pulsed signal and optical data signal from said saturable absorber mirror to said first and second optical circulators, respectively;
a balanced photodetector on which the reflected light rays of said optical pulsed signal and optical data signal coming from said saturable absorber mirror and branched off by said first and second optical circulators impinge, the balanced photodetector producing an electrical output signal corresponding to the difference in optical power between the impinging signals; and
an oscillator for producing a signal to said pulsed light source, the signal being used to control phase of said optical pulsed signal based on the output signal from the balanced photodetector.

4. An optical clock extraction circuit for extracting an optical clock signal phase-locked to a high-speed optical data signal, said optical clock extraction circuit comprising:
a saturable absorber mirror;
a passively mode-locked laser emitting an optical pulsed signal consisting of repetitive optical pulses;
a first optical coupler/splitter for passing said optical data signal and causing reflected light of said optical pulsed signal from said saturable absorber mirror to branch off;
a second optical coupler/splitter for passing said optical pulsed signal and causing it to branch off to take out it as said optical clock signal, said second optical coupler/splitter also acting to cause reflected light of said optical data signal from said saturable absorber mirror to branch off;
first and second lenses for collecting said optical data signal and optical pulsed signal passed through said first and second optical coupler/splitters at the same position on said saturable absorber mirror and for returning reflected light rays of said optical pulsed signal and optical data signal from said saturable absorber mirror to said first and second optical coupler/splitters, respectively;
a balanced photodetector on which the reflected light rays of said optical pulsed signal and optical data signal coming from said saturable absorber mirror and branched off by said first and second optical coupler/splitters impinge, the balanced photodetector producing an electrical output signal corresponding to the difference in optical power between the impinging signals; and
a frequency control circuit for controlling frequency of said passively mode-locked laser based on the output signal from the balanced photodetector.

5. An optical clock extraction circuit as set forth in any one of claims 1 to 3, wherein said pulsed light source is an actively mode-locked laser.

6. An optical clock extraction circuit as set forth in any one of claims 1 to 4, wherein said saturable absorber mirror is a semiconductor saturable absorber mirror.

7. An optical clock extraction circuit as set forth in any one of claims 1 to 4, wherein said saturable absorber mirror uses carbon nanotubes.

8. An optical clock extraction circuit as set forth in any one of claims 1 to 4, wherein said optical data signal and optical pulsed signal propagate through optical waveguides.
